(19) United States
(12) Patent Application Publication
(10) Pub. No.: US 2011/0301983 A1
(43) Pub. Date: Dec. 8, 2011

(54) System and Method for Quoting, Selling, Distributing and Tracking Insurance Products

(75) Inventor: Carmine Guida, New York, NY (US)

(73) Assignee: Click and Bind, LLC, Largo, FL (US)

(21) Appl. No.: 12/794,263

(22) Filed: Jun. 4, 2010

(51) Int. Cl. G06Q 40/00

(52) U.S. Cl. 705/4

(57) ABSTRACT

The system relates to an automated method for selling a variety of insurance products to a single individual user. In one aspect of the system, a first database is used for storing demographic information about the user, a second database is used for mapping property types to available insurance products, and the system reuses demographic information stored and retrieved from the first database to provide insurance quotes for a plurality of insurance products.

### TECHNICAL FIELD

This disclosure relates to a system and method for selling a variety of insurance products to a single individual user. More specifically, this disclosure relates to a system and method for determining which types of property the user has an interest in, determining available insurance products for those property types, and re-using personal information collected a single time from the user to generate quotes for a plurality of insurance products.

### BACKGROUND OF THE INVENTION

Numerous insurance quoting systems exist in the marketplace today. Selling insurance products over the Internet is not new. But users can get “form shock” on websites as they are presented with numerous questions they must answer in order to get a quote.

Typically, users must go to a particular carrier and find out what insurance products they offer. The user will need to go through that carrier's respective quoting process. This process will include collecting personal information about the user. If the user wants to compare that carrier's products to another carrier's products, she will need to go to the second carrier's quoting process and re-enter much of the same information. She can then get the comparative quote and make a decision as to which insurance product to purchase. She will then need to return to the respective carrier's quoting process and begin the purchasing process with that carrier.

This requires additional effort on the part of the user to re-enter information she has previously entered. Additionally, the insurance providers (both carriers who service insurance products, and agents who sell them) miss out on the opportunity to cross-sell other related products which the user might be interested in.

Hence, there exists a need in the industry to overcome these problems and provide a method and system for selling a variety of insurance products to a single user. There also exists a need to re-use personal information collected to quote a first insurance product when generating a quote for a second insurance product.

### SUMMARY OF THE INVENTION

According to one embodiment of the present disclosure, a system is disclosed which implements an automated method for selling a variety of insurance products to a single individual user. In one aspect of the system, a first database is used for storing demographic information about the user, a second database is used for mapping property types to available insurance products, and the system reuses demographic information stored and retrieved from the first database to provide insurance quotes for a plurality of insurance products.

An advantage is the ability to reuse a user's personal information in quoting numerous and different insurance products without requiring a user to reenter that information.

Another advantage is the ability to collect information about other properties the user has an interest in, and consult a second database of available insurance products to cross-sell additional relevant insurance products to the user.

Various embodiments of the invention may have none, some, or all of these advantages. Other technical advantages of the present invention will be readily apparent to one skilled in the art.

### BRIEF DESCRIPTION OF THE DRAWINGS

For a more complete understanding of the present disclosure and its advantages, reference is now made to the following descriptions, taken in conjunction with the accompanying drawings, in which:

FIG. 1 is a block diagram illustrating one embodiment of a system for selling a variety of insurance products to a single individual user in accordance with the teachings of the present disclosure.

FIG. 2 is a flow chart illustrating one embodiment of the steps that may be performed by the system of FIG. 1.

FIG. 3 is an illustration of a second database which may be used by the system of FIG. 1.

FIG. 4 is an example display presented by the system of FIG. 1.

### DETAILED DESCRIPTION OF THE DRAWINGS

The disclosed system relates to a system and method for selling a variety of insurance products to a single individual user. In one aspect, the system gathers information from a user about a first insurance product, presents the user with a list of other insurance products, and then gathers information about a second insurance product. The system reuses certain demographic information in quoting both the first and second insurance product. Details regarding the system and associated method are discussed below.

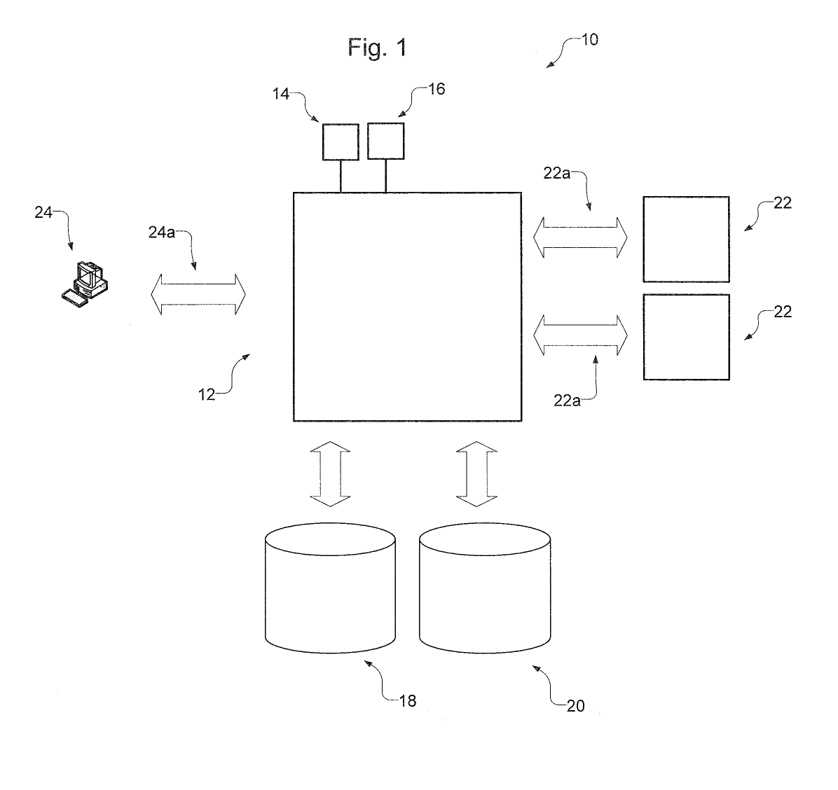

One embodiment of a system for selling a variety of different insurance products is illustrated in FIG. 1. The system 10 comprises a cross-selling engine 12, which includes a processing unit 14 and memory 16, first 18 and second 20 databases and a plurality of insurance quoting engines 22.

The system 10 can be implemented on one or more computing systems, which can include a personal computer, a workstation, a network computer, hand held device, or any other suitable processing device. Further, the system 10 can be written as a software program in any appropriate computer language, such as, for example, C, C++, C#, Java, Assembler, Tcl, Lisp, Javascript, or any other suitable language. In one embodiment, the system 10 is implemented as a web-based application.

The processing unit 14 can be any computer processing unit, and could be a single central processing unit, or a number of processing units configured to operate either in sequence or in parallel. The processing unit 14 can be configured to execute software processes which implement the steps disclosed herein.

The memory 16 is any computer memory capable of storing the steps necessary for the processing unit 14 to implement the steps disclosed herein. The memory 16 may be in the form of memory resident within the processing unit or in the form of standalone memory coupled to the processing unit via a communication path, such as a bus or a network.

The first database 18 can be any system for storing data, including a file system, a database system, a hard drive, random access memory, and likewise may be resident or remotely coupled via a network. In a preferred embodiment, the first database 18 is a relational database, such as SQLServer® distributed by Microsoft®.

Similarly, the second database 20 can be any system for storing data, including a file system, a database system, a hard drive, random access memory, and likewise may be resident or remotely coupled via a network.

A plurality of insurance quoting engines 22 are also depicted. In a preferred embodiment, an insurance quoting engine is an application programming interface provided by an insurance company which permits agents and others with access to quote and sell insurance products. As shown, the insurance quoting engines 22 are communicatively connected to the cross-selling engine 12 via a communications path 22a. In a preferred embodiment, the communications path 22a is the Internet, but could be any communication path. For instance, communication path 22a could be a proprietary communications protocol and path. Communication path 22a could also be any network communication path, including a Local Area Network, a Wide Area Network, a wired network, a wireless network, and the like.

Also depicted in FIG. 1 is a user's computer 24 (not part of the system 10). The user's computer 24 could be any computing device, such as a personal computer, a laptop, a server, a personal digital assistant, a smartphone, or any other device capable of communicating with the system 10. In a preferred embodiment, the communication (depicted as arrow 24a) between the user's computer 24 and the system 10 takes place over the Internet. As would be understood to one of skill in the art, the communication path 26 could be any network communication path, including a Local Area Network, a Wide Area Network, a wired network, a wireless network, and the like.

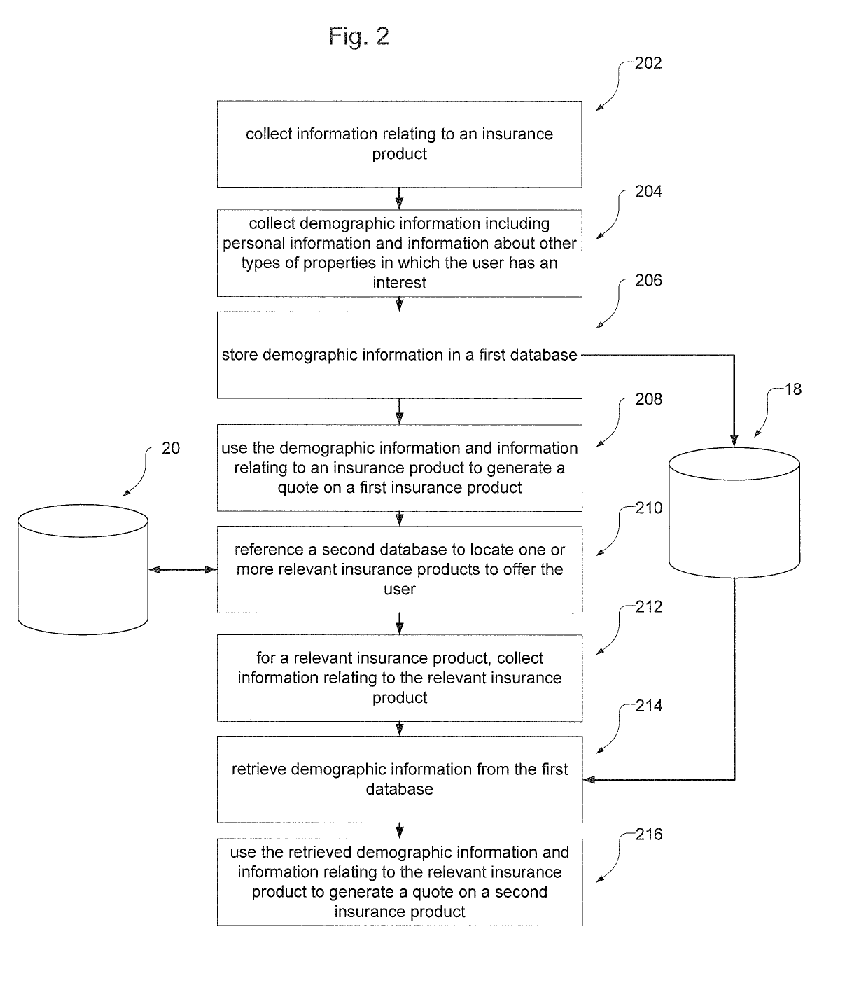

FIG. 2 is a flow chart presenting steps that may be taken by the present system in a preferred embodiment. Beginning at step 202, the system 10 collects information relating to an insurance product from the user 24. This information may include the type of property to insure, the amount of insurance desired, the preferred deductible, and other coverages that may be relevant to an insurance product for the particular property. For instance, if the insurance product the user 24 is interest in is to insure an automobile, the information collected at step 202 can include the type of automobile, information on the primary driver's driving history, the annual mileage, information pertaining to where the automobile is stored, and the like.

At step 204, the system collects demographic information about the user. Notably, while step 204 is depicted below step 202, this is not a requirement for the present disclosure. As would be evident to one of skill in the art, steps 202 and 204 can happen in any order. During step 204, the system 10 collects demographic information from and about the user. This demographic information may include personal information such as name, age, birth date, social security number, and the like.

This demographic information will also include information pertaining to other properties in which the user has an interest. For instance, the system 10 may ask the user “Do you own any of the following: Boat, Jet Ski, Motorcycle, Home, etc.” The system 10 can use any other mechanism for gathering this information. For example, the system 10 may use the user's 24 address information to automatically search public records to determine if the user owns a home. Similarly, the system 10 may consult any other database to determine if the user owns other property like a boat or car.

The system will next store this demographic information in a first database 18 at step 206. Included in this demographic information is information about other types of property in which the user has an interest.

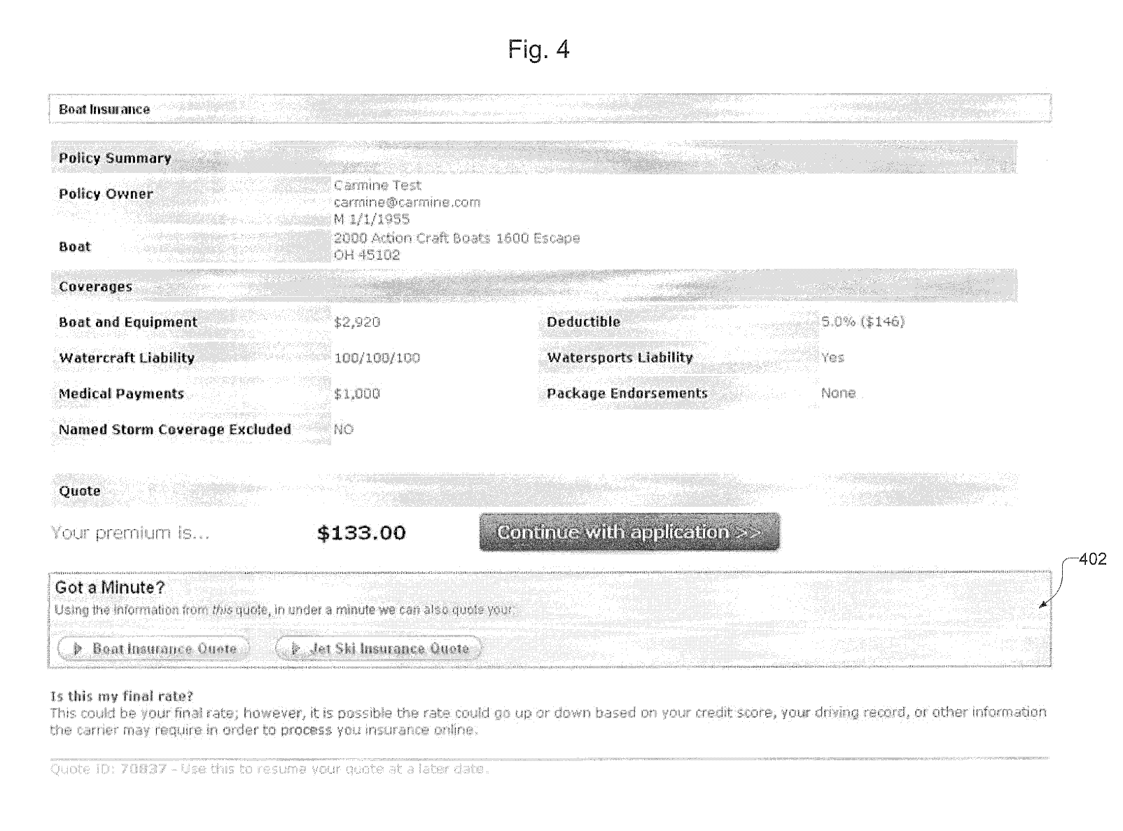

Next, at step 208, the system 10 will use the demographic information and information obtained in step 202 to generate an insurance quote for the property identified in step 202. See FIG. 4. In a preferred embodiment, the system 10 calls out to an insurance quoting engine 22 in order to get an insurance quote.

In an alternate embodiment, the system 10 could include its own insurance quoting engine 22. In this embodiment, the communication path 22a would be a local communication path, such as a bus or other data path. As would be evident to one of skill in the art, an insurance quoting engine 22 may be implemented as a computer function, and step 208 would then be implemented as a call to that function.

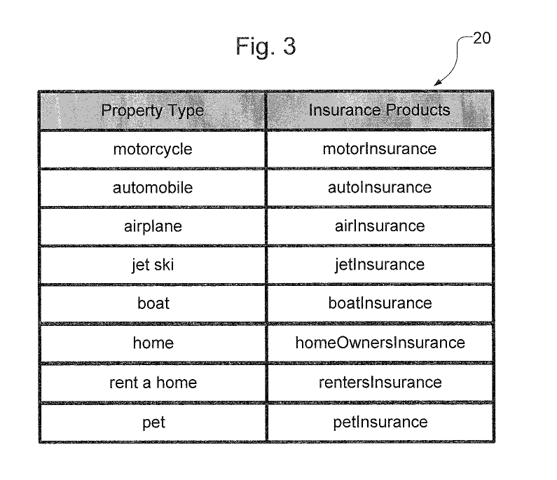

Returning to FIG. 2, the system next references a second database 20 to locate one or more relevant insurance products to offer the user. FIG. 3 depicts a sample of what may be contained in the second database 20. Second database 20 may contain a mapping of property types to available insurance products. In the example of FIG. 3, second database 20 maps the “motorInsurance” product to “motorcycle” property types, “autoInsurance” product to “automobile” property types and so forth. As would be evident to one of skill in the art, there can be numerous entries for each property type, for instance the system 10 can provide different or competing insurance products for each respective property type.

At step 210, the system 10 uses the information collected earlier pertaining to other property types in which the user has an interest, and references the second database 20 to determine other available insurance products to offer. For example, if the user informed the system 10 that she owned a motorcycle and a jet ski (in addition to the property she was already seeking to insure), the system 10 would determine from the second database 20 that the system 10 could offer a motorcycle insurance product (namely “motorInsurance” as depicted in FIG. 3) and a jet ski insurance product (namely “jetInsurance” depicted in FIG. 3).

As shown in FIG. 4, the system 10 may display a prompt 402 to the user 24 indicating other available insurance products, thus enabling the system 10 to cross-sell other relevant insurance products based on the information collected from the user earlier.

Next, at step 212, for each relevant insurance product identified, the system would collect information pertaining to that particular insurance product from the user. For instance, following the above example, if the additional insurance product was for a jet ski, the system may collect information about the type of jet ski, the age of the primary user, where it stored, and so forth.

Rather than requiring the user to re-enter her personal information, the system next consults the first database 18 and retrieves this personal information at step 214.

Finally, at step 216, the system 10 uses the retrieved personal information and the information collected at step 212 to generate a second insurance quote. In a preferred embodiment, the system 10 generates the second insurance quote by providing the personal information and information collected at step 212 to a second insurance quoting engine 22. As would be understood by those of skill in the art, the second insurance quoting engine 22 could be the same as the first insurance quoting engine 22, or could be an internal process of the system 10.

While not depicted in the flow chart of FIG. 2, the system 10 may also complete the sale of the respective insurance products after steps 208 and 216. For instance, prior to proceeding to step 210, the system may collect payment information from the user and sell the insurance product quoted in step 208 to the user. Upon completion of that sale, the system could move to step 210. Similarly, the system 10 may follow step 216 by collecting additional payment information in order to complete the sale of the second insurance product.

Alternatively, the system 10 may complete the sales of all relevant insurance products offered to the user after the user has completed the process described in FIG. 2 for all property types identified. In this example, step 216 may be followed by another step of presenting all the quoted insurance products to the user and permitting the user to select any number of them. The system 10 could then proceed to collect a single set of payment information, and reuse that payment information to purchase all of the selected insurance products.

Although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. An Internet-based method for selling a variety of insurance products to a single individual user, the method comprising:
collecting information from the user relating to a policy for insurance on a first property owned by the user, wherein the information includes demographic information about the user including name, address and date of birth;
storing the demographic information in a first database for future reference;
collecting property information about the first property to insure, the information including the type of property;
providing the demographic and property information to a first insurance quoting engine to generate a quote for the first insurance product;
providing a second database containing a mapping of property types to available insurance products;
collecting information about other types of properties in which the user has an interest;
referencing the second database to locate one or more relevant insurance products to offer to the user based upon the other types of properties in which the user has an interest;
for each relevant insurance product to offer to the user, collecting information from the user relating to the relevant insurance product;
retrieving the stored demographic information from the first database; and
providing the retrieved demographic information and information relating to the relevant insurance product to a second insurance quoting engine to generate a quote for the relevant insurance product.

2. A method for selling insurance products to a user, the method comprising:
collecting demographic information from the user;
storing the demographic information;
collecting information from the user relating to an insurance policy for a first property to insure;
using the demographic information and the information from the user to generate an insurance quote for the first property to insure;
mapping property types to available insurance products;
using the mapping to collect additional information from the user concerning a second property to insure; and
using the demographic information and the additional information to generate an insurance quote for the second property to insure.

3. The method of claim 2 wherein storing the demographic information is stored in a database.

4. The method of claim 2 wherein mapping property types is implemented by way of a database.

5. The method of claim 2 wherein the property types comprises motorcycles, automobiles, boats, and jet skis.

6. A system for selling a variety of insurance products to a user comprising:
a cross-selling engine, configured to collect demographic information and information pertaining to property in which the user has an interest;
a first database, communicatively coupled to the cross-selling engine, wherein the cross-selling engine stores the demographic information in the first database;
a first insurance quoting engine, communicatively coupled to the cross-selling engine, wherein the cross-selling engine provides the demographic information and a first property information to the first insurance quoting engine so that the first insurance quoting engine can generate a quote for an insurance policy for the first property; and
a second database, communicatively coupled to the cross-selling engine, wherein the second database maps available insurance products to property types, wherein the cross-selling engine utilizes the second database to determine a second insurance product to quote for the user, and then gathers information from the user pertaining to the second insurance product; and
a second insurance quoting engine, communicatively coupled to the cross-selling engine, wherein the cross-selling engine retrieves the demographic information from the first database and then provides the demographic information and the information pertaining to the second insurance product to the second insurance quoting engine so that the second insurance quoting engine can generate a quote for an insurance policy for the second property.

7. A system for selling insurance products comprising
a first database for storing user information;
a second database for storing available insurance products; and
a cross-selling engine comprising a memory and a processing unit, the cross-selling engine configured for:
gathering user information and storing the user information in the first database,
gathering first insurance information and using the user information and first insurance information to generate a first insurance quote;
using the second database to determine other available insurance products;
gathering second insurance information, retrieving the user information from the first database, and using the user information and second insurance information to generate a second insurance quote.

8. The system of claim 7 further comprising
an insurance quoting engine, wherein the cross-selling engine generates a first insurance quote by providing the user information and the first insurance information to the insurance quoting engine and receives the insurance quote from the insurance engine.

9. The system of claim 7 wherein the second database is a relational database.

10. The system of claim 7 wherein the second database is a text file.

11. The system of claim 7 wherein the first database and second database are stored on the same storage device.

12. The system of claim 7 wherein the cross-selling engine is implemented as a web-based application.

13. The system of claim 12 wherein the user provides information to the cross-selling engine by accessing a web page.
